(19) United States
(12) Patent Application Publication
(10) Pub. No.: US 2025/0202157 A1
(43) Pub. Date: Jun. 19, 2025

(54) CONNECTOR ASSEMBLY

(71) Applicant: Ying Hao Technology Co., Ltd., New Taipei City (TW)

(72) Inventor: Chih-Jung CHEN, New Taipei City (TW)

(73) Assignee: Ying Hao Technology Co., Ltd., New Taipei City (TW)

(21) Appl. No.: 18/918,115

(22) Filed: Oct. 17, 2024

(30) Foreign Application Priority Data
Dec. 19, 2023 (TW) 112213882

(51) Int. Cl. H01R 13/506; H01R 12/77

(52) U.S. Cl. CPC H01R 13/506; H01R 12/778

(57) ABSTRACT

A connector assembly includes an inverted U-shaped case body which includes an upper cover body and two lateral bodies, an isolation insert plate, a first flexible cable, a second flexible cable, an upper insulating holding member, and a lower insulating holding member. Each of the two lateral bodies has at least one buckle hole, and two inner sides of the two lateral bodies respectively have a vertical concave portion. The isolation insert plate includes upper and lower surfaces, and each of two sides of a rear end of the isolation insert plate has a vertical engagement portion to be engaged with the concave portion.

### CROSS REFERENCE TO RELATED APPLICATIONS

The present application claims priority of the Taiwan patent application No. 112213882, filed on Dec. 19, 2023 with the Taiwan Intellectual Property Office, titled “CONNECTOR ASSEMBLY”, which is incorporated by reference in the present application in its entirety.

### FIELD OF INVENTION

The present disclosure relates to a connector assembly, and more particularly, to a connector assembly with an extremely simple structure.

### BACKGROUND OF INVENTION

Existing flexible flat cables (Flex Flat Cable, FFC) or flexible printed circuit cables developed by industries can be automated mass production and are very suitable for control of high-frequency signal transmission. The flexible flat cables have characteristics of neatly arranged wire cores, large transmission capacities, flat structures, compact sizes, and flexibilities, so they can be flexibly used as power supplies and data transmission conductor wirings in various electronic products.

As is well known in the industries, a multi-layered printed circuit board is usually used as a connector tongue in conventional technologies, and after the connector tongue is made first, contact parts of a flexible flat cable are welded to soldering parts of a plurality of wires disposed on the multi-layered printed circuit board. However, as long as high-frequency transmission of electronic signals undergoes multi-media transmission (for example, one more solder joint and one more transmission component in a connector), loss and degradation of the signals will inevitably increase. Therefore, a connector assembly made by conventional technologies not only has a large number of components, but also increases difficulty of achieving a high reliability. Therefore, a design of a connector assembly having an extremely simple and compact structure, a simple manufacturing process, and a high reliability is an urgent priority for the industries. Therefore, it is also an important urgent issue in the present disclosure.

Therefore, with a design of a lighter, thinner, smaller, and more affordable connector assembly bound to become a mainstream, and based on a premise that requirements for transmission specifications mentioned previously are getting higher and higher, it is necessary to provides connector assemblies having extremely simple and compact structures, simple manufacturing processes, and high reliabilities. It is also an important urgent issue in the present disclosure.

### SUMMARY OF INVENTION

In view of this, it is necessary to provide a connector assembly having an extremely simple and compact structure, a simple manufacturing process, and a high reliability, to solve problems in the conventional technology.

An embodiment of the present disclosure provides a connector assembly which includes:
an inverted U-shaped case body which includes an upper cover body and two lateral bodies, wherein, each of the two lateral bodies has at least one buckle hole, and two inner sides of the two lateral bodies respectively have a vertical concave portion;
an isolation insert plate which includes upper and lower surfaces, wherein, each of two sides of a rear end of the isolation insert plate has a vertical engagement portion to be engaged with the concave portion;
a first flexible cable which includes a first contact part disposed on the upper surface of the isolation insert plate;
a second flexible cable which includes a second contact part disposed on the lower surface of the isolation insert plate;
an upper insulating holding member disposed on an upper rear side of the engagement portion and located between the upper cover body and the first flexible cable; and
a lower insulating holding member disposed on a lower rear side of the engagement portion, wherein, each of two sides of the lower insulating holding member has at least one buckle protruding portion respectively correspondingly buckled into the at least one buckle hole.

In an embodiment of the connector assembly of the present disclosure, the upper insulating holding member and the isolation insert plate are integrally formed.

In an embodiment of the connector assembly of the present disclosure, the lower insulating holding member and the isolation insert plate are integrally formed. The upper insulating holding member and the inverted U-shaped case body are integrally formed.

In an embodiment of the connector assembly of the present disclosure, the connector assembly further includes a flat spring disposed in a flat spring engaging slot on an outside of the upper cover body.

In an embodiment of the connector assembly of the present disclosure, a front end of the isolation insert plate further includes an insert-plate tongue portion. A maximum height of the insert-plate tongue portion is 1.8 mm.

In an embodiment of the connector assembly of the present disclosure, the isolation insert plate further includes a jagged edge disposed on the upper surface, and the jagged edge is formed at a junction of the insert-plate tongue portion and the upper surface. The isolation insert plate further includes another jagged edge disposed on the lower surface, and the another jagged edge is formed at a junction of the insert-plate tongue portion and the lower surface.

In an embodiment of the connector assembly of the present disclosure, the first contact part includes a jagged-edge arrayed front end corresponding to the jagged edge. The second contact part includes a jagged-edge arrayed front end corresponding to the another jagged edge.

In an embodiment of the connector assembly of the present disclosure, the first flexible cable and the second flexible cable are flexible flat cables.

In an embodiment of the connector assembly of the present disclosure, the first flexible cable and the second flexible cable are flexible printed circuit cables.

Compared to existing connector assemblies, the connector assembly in the present disclosure does not use a multi-layered circuit board as a connector tongue, but uses the isolation insert plate as the connector tongue. Also, the isolation insert plate can optionally be integrally formed with the upper insulating holding member. Or, it can optionally be integrally formed with the lower insulating holding member, while the upper insulating holding member is integrally formed with the inverted U-shaped case body. Therefore, the connector assembly in the present disclosure not only has an extremely simple and compact structure, but also has a simple manufacturing process and a high reliability. More importantly, it is unnecessary to weld the multi-layered circuit board with flexible cables as in the conventional technology, which causes high-frequency transmission of electronic signals to undergo multi-media transmission, thereby increasing signal loss and degradation and reducing reliabilities.

### DESCRIPTION OF DRAWINGS

In order to make above content of the present disclosure more obvious and easier to understand, preferred embodiments and their accompanying drawings are described in detail in the following.

FIG. 1 is a top perspective view of construction of a connector assembly according to a first embodiment of the present disclosure.

FIG. 2 is a bottom perspective view of construction of the connector assembly according to the first embodiment of the present disclosure.

FIG. 3 is a top exploded perspective view of the connector assembly according to the first embodiment of the present disclosure.

FIG. 4 is a bottom exploded perspective view of the connector assembly according to the first embodiment of the present disclosure.

FIG. 5 is a top perspective view of an isolation insert plate and a lower insulating holding member of the connector assembly according to the first embodiment of the present disclosure.

FIG. 6 is a rear perspective view of the isolation insert plate and the lower insulating holding member of the connector assembly according to the first embodiment of the present disclosure.

FIG. 7 is a top perspective view of an inverted U-shaped case body of the connector assembly according to the first embodiment of the present disclosure.

FIG. 8 is a bottom perspective view of the inverted U-shaped case body of the connector assembly according to the first embodiment of the present disclosure.

FIG. 9 is a top perspective view of construction of another connector assembly according to a second embodiment of the present disclosure.

FIG. 10 is a bottom perspective view of construction of the connector assembly according to the second embodiment of the present disclosure.

FIG. 11 is a top exploded perspective view of the connector assembly according to the second embodiment of the present disclosure.

FIG. 12 is a bottom exploded perspective view of the connector assembly according to the second embodiment of the present disclosure.

FIG. 13 is a top perspective view of an isolation insert plate, an upper insulating holding member, and a lower insulating holding member of the connector assembly according to the second embodiment of the present disclosure.

FIG. 14 is a rear perspective view of the isolation insert plate, the upper insulating holding member, and the lower insulating holding member of the connector assembly according to the second embodiment of the present disclosure.

FIG. 15 is a top perspective view of an inverted U-shaped case body of the connector assembly according to the second embodiment of the present disclosure.

FIG. 16 is a bottom perspective view of the inverted U-shaped case body of the connector assembly according to the second embodiment of the present disclosure.

### DETAILED DESCRIPTION OF PREFERRED EMBODIMENTS

In order to further understand characteristics, technical means, and specific functions and purposes of the present disclosure, more specific embodiments are listed, followed by detailed descriptions with figures and figure numbers.

Following description of each embodiment refers to accompanying drawings to illustrate specific embodiments in which the present disclosure can be implemented. Directional terms mentioned in the present disclosure, such as “upper”, “lower”, “front”, “rear”, “left”, “right”, “top”, “bottom”, “horizontal”, “vertical”, etc., only refer to directions of the accompanying drawings. Therefore, the directional terms used herein are used to explain and understand the present disclosure, rather than to limit the present disclosure.

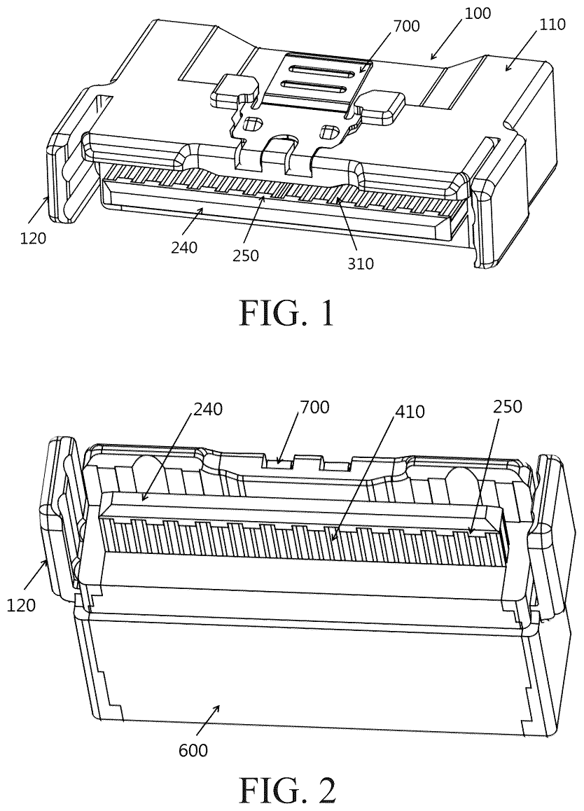

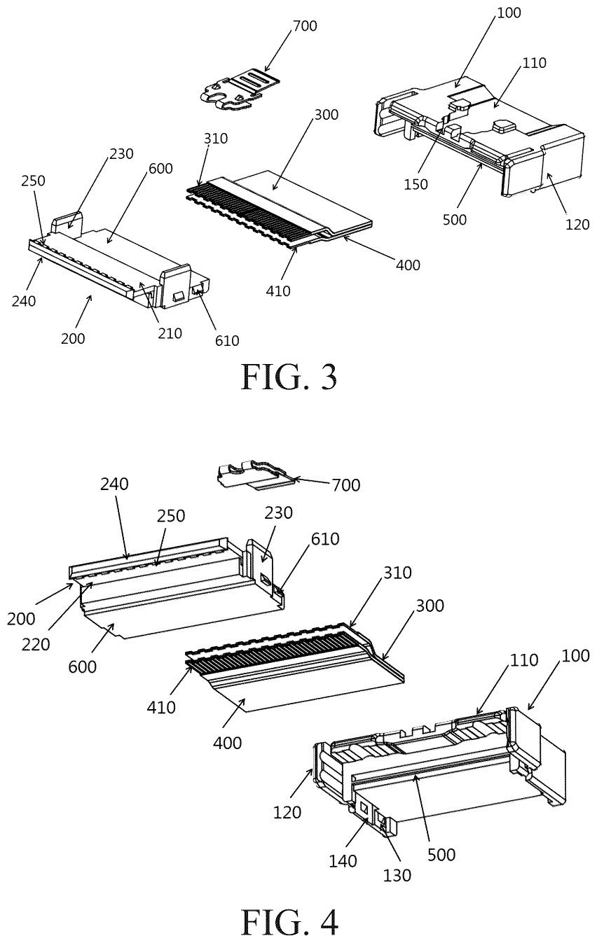

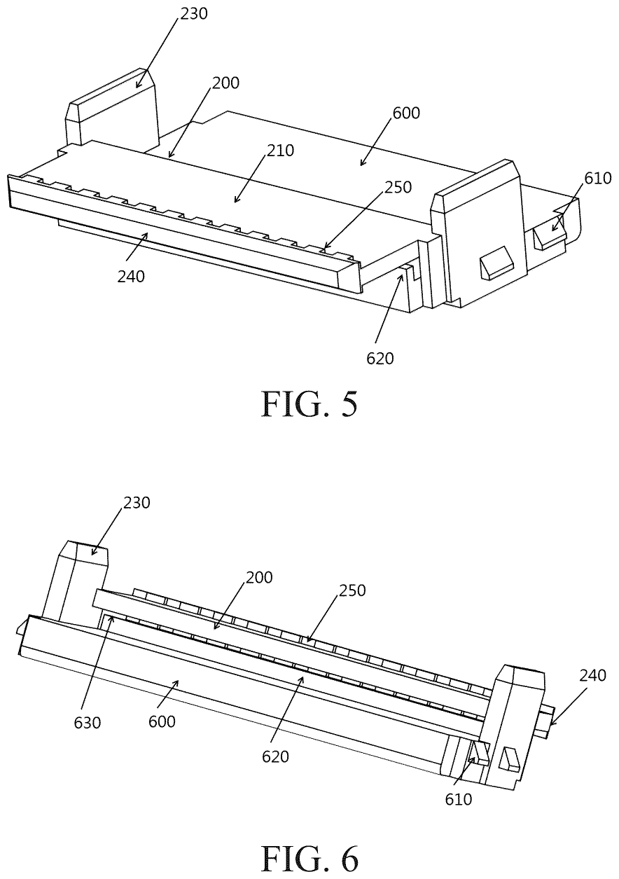

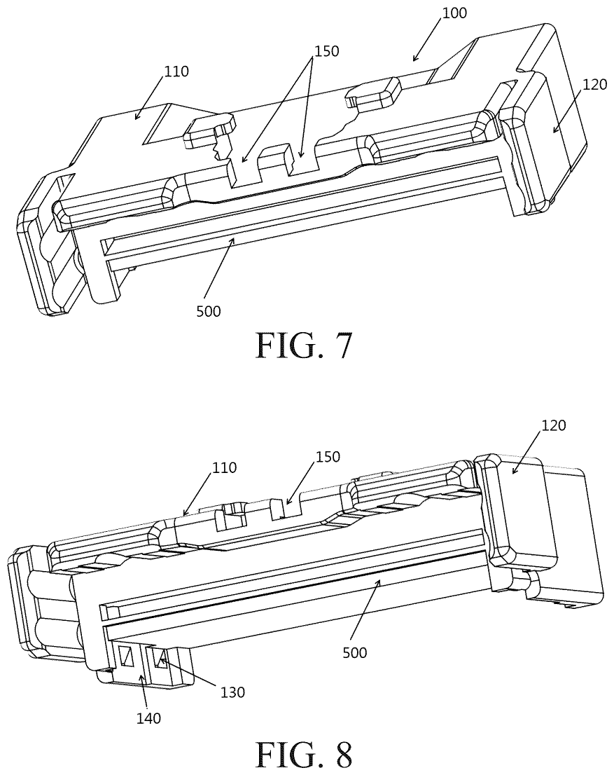

Please refer to FIGS. 1 to 8. FIG. 1 is a top perspective view of construction of a connector assembly according to a first embodiment of the present disclosure. FIG. 2 is a bottom perspective view of construction of the connector assembly according to the first embodiment of the present disclosure. FIG. 3 is a top exploded perspective view of the connector assembly according to the first embodiment of the present disclosure. FIG. 4 is a bottom exploded perspective view of the connector assembly according to the first embodiment of the present disclosure. FIG. 5 is a top perspective view of an isolation insert plate 200 and a lower insulating holding member 600 of the connector assembly according to the first embodiment of the present disclosure. FIG. 6 is a rear perspective view of the isolation insert plate 200 and the lower insulating holding member 600 of the connector assembly according to the first embodiment of the present disclosure. FIG. 7 is a top perspective view of an inverted U-shaped case body 100 of the connector assembly according to the first embodiment of the present disclosure. FIG. 8 is a bottom perspective view of the inverted U-shaped case body 100 of the connector assembly according to the first embodiment of the present disclosure.

As shown in FIGS. 1 to 8, the connector assembly according to the first embodiment of the present disclosure includes the inverted U-shaped case body 100, the isolation insert plate 200, a first flexible cable 300, a second flexible cable 400, an upper insulating holding member 500, the lower insulating holding member 600, and a flat spring 700. The inverted U-shaped case body 100 includes an upper cover body 110 and two lateral bodies 120. Wherein, each of the two lateral bodies 120 has at least one buckle hole 130, and two inner sides of the two lateral bodies 120 respectively have a vertical concave portion 140. The isolation insert plate 200 includes upper and lower surfaces 210,220. Wherein, each of two sides of a rear end of the isolation insert plate 200 has a vertical engagement portion 230 to be engaged with the concave portion 140 of the two inner sides of the two lateral bodies 120 of the inverted U-shaped case body 100. The first flexible cable 300 includes a first contact part 310 disposed on the upper surface 210 of the isolation insert plate 200. The second flexible cable 400 includes a second contact part 410 disposed on the lower surface 220 of the isolation insert plate 200. As shown in the figures, the upper insulating holding member 500 is disposed on an upper rear side of the engagement portion 230 and is located between the upper cover body 110 and the first flexible cable 300. The lower insulating holding member 600 is disposed on a lower rear side of the engagement portion 230, and each of two sides of the lower insulating holding member 600 has at least one buckle protruding portion 610 respectively and correspondingly buckled into the at least one buckle hole 130. The connector assembly further includes the flat spring 700 disposed in a flat spring engaging slot 150 on an outside of the upper cover body 110.

As shown in the figures, in the first embodiment of the present disclosure, the lower insulating holding member 600 and the isolation insert plate 200 are integrally formed, and the upper insulating holding member 500 and the inverted U-shaped case body 100 are integrally formed. As shown in the figures, in the first embodiment of the present disclosure, a front end of the isolation insert plate 200 further includes an insert-plate tongue portion 240. As shown in the figures, the insert-plate tongue portion 240 has a trapezoidal shape of cross-section. When the connector assembly is connected to a corresponding connector interface, the trapezoidal shape facilitates the isolation insert plate 200 to easily accomplish the connection. A maximum height of the insert-plate tongue portion 240 is 1.8 mm. The isolation insert plate 200 further includes a jagged edge 250 disposed on the upper surface 210, and the jagged edge 250 is formed at a junction of the insert-plate tongue portion 240 and the upper surface 210. The isolation insert plate 200 further includes another jagged edge 250 disposed on the lower surface 220, and the another jagged edge 250 is formed at a junction of the insert-plate tongue portion 240 and the lower surface 220.

As shown in the figures, the first contact part 310 of the first flexible cable 300 and the second contact part 410 of the second flexible cable 400 also include jagged-edge arrayed front ends that correspond to the jagged edges 250, thereby being beneficial to improve assembling yields. When assembling the connector assembly, first, the first contact part 310 is disposed on the upper surface 210 of the isolation insert plate 200 and fixed, and then the second contact part 410 is disposed on the lower surface 220 of the isolation insert plate 200 and fixed. The first contact part 310 and the second contact part 410 can be connected and fixed on the upper surface 210 and the lower surface 220 by adhesives or other methods. Rear sections of the first flexible cable 300 and the second flexible cable 400 having an insulating layer can also be fixed by the adhesives or can only be aligned and abutted by cable ties or other means for facilitating subsequent use or line arrangement.

In addition, in the first embodiment of the present disclosure, the second contact part 410 of the second flexible cable 400 is fixed to the lower surface 220 of the isolation insert plate 200 after passing through a gap 630 formed between a hold-up wall 620 of the lower insulating holding member 600 and the isolation insert plate 200 as shown in FIG. 6. Afterwards, when the at least one buckle protruding portion 610 of the lower insulating holding member 600 is buckled into the at least one buckle hole 130 of the two lateral bodies 120 of the inverted U-shaped case body 100, and the assemblement of the connector assembly is about to be accomplished, the upper insulating holding member 500, which is integrally formed with the inverted U-shaped case body 100, and the lower insulating holding member 600 can hold the first flexible cable 300 and the second flexible cable 400 inbetween from up and down, thereby accomplishing the assemblement of the connector assembly.

In addition, in the first embodiment of the present disclosure, the first flexible cable 300 and the second flexible cable 400 are flexible flat cables or flexible printed circuit (Flex Printed Circuit, FPC) cables. Furthermore, as shown in the figures, the at least one buckle hole 130 of the two lateral bodies 120 of the inverted U-shaped case body 100 is not a through hole but a blind hole.

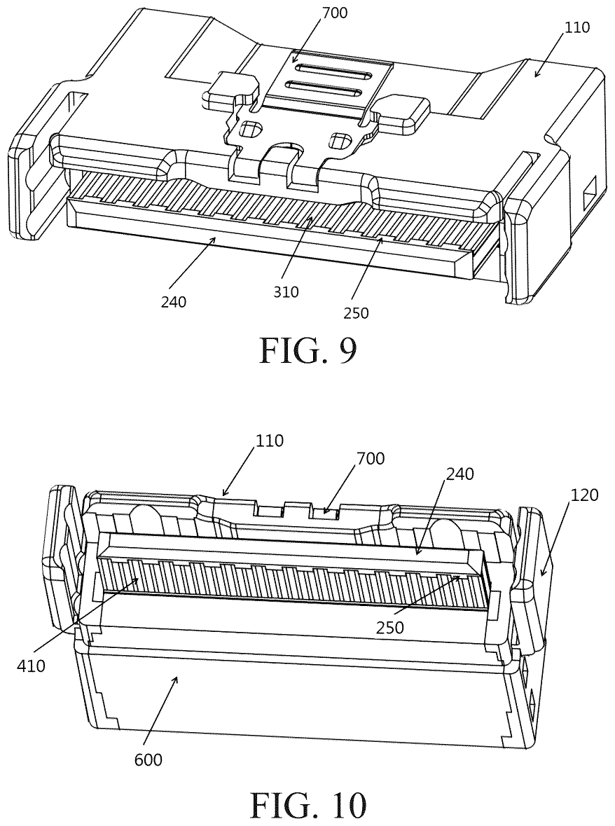

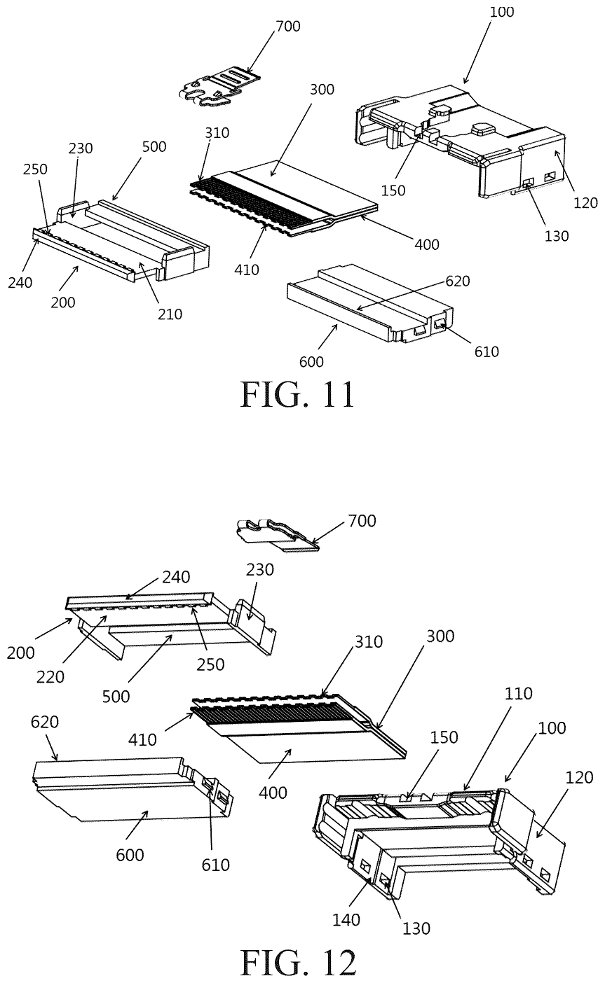

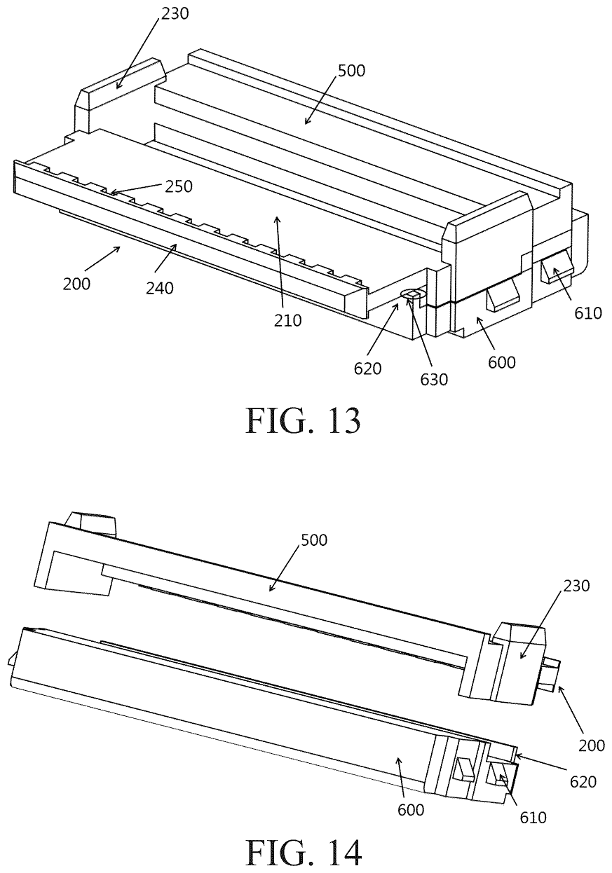

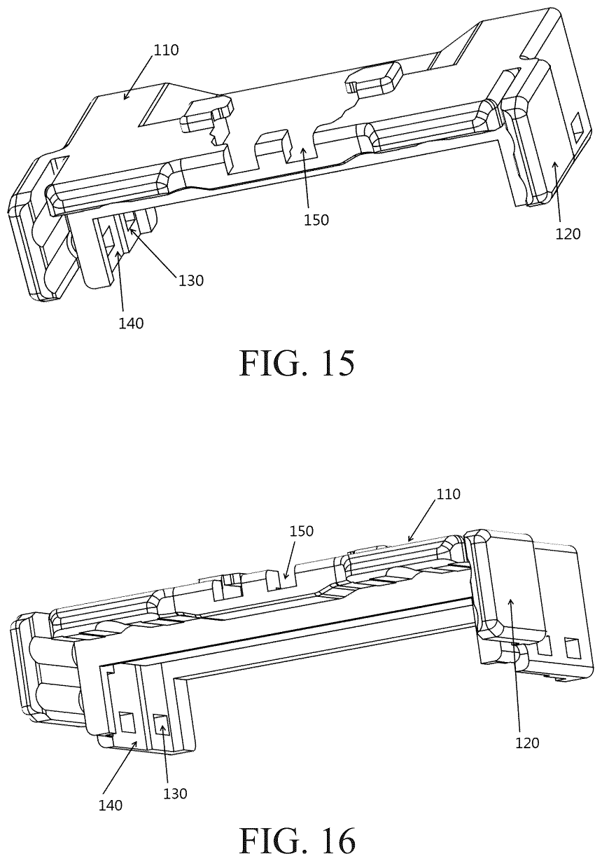

Please refer to FIGS. 9 to 16. FIG. 9 is a top perspective view of construction of another connector assembly according to a second embodiment of the present disclosure. FIG. 10 is a bottom perspective view of construction of the connector assembly according to the second embodiment of the present disclosure. FIG. 11 is a top exploded perspective view of the connector assembly according to the second embodiment of the present disclosure. FIG. 12 is a bottom exploded perspective view of the connector assembly according to the second embodiment of the present disclosure. FIG. 13 is a top perspective view of an isolation insert plate 200, an upper insulating holding member 500, and a lower insulating holding member 600 of the connector assembly according to the second embodiment of the present disclosure. FIG. 14 is a rear perspective view of the isolation insert plate 200, the upper insulating holding member 500, and the lower insulating holding member 600 of the connector assembly according to the second embodiment of the present disclosure. FIG. 15 is a top perspective view of an inverted U-shaped case body 100 of the connector assembly according to the second embodiment of the present disclosure. FIG. 16 is a bottom perspective view of the inverted U-shaped case body 100 of the connector assembly according to the second embodiment of the present disclosure.

As shown in FIGS. 9 to 16, the connector assembly of the present disclosure includes the inverted U-shaped case body 100, the isolation insert plate 200, a first flexible cable 300, a second flexible cable 400, the upper insulating holding member 500, the lower insulating holding member 600, and a flat spring 700. The inverted U-shaped case body 100 includes an upper cover body 110 and two lateral bodies 120. Wherein, each of the two lateral bodies 120 has at least one buckle hole 130, and two inner sides of the two lateral bodies 120 respectively have a vertical concave portion 140. The isolation insert plate 200 includes upper and lower surfaces 210,220. Wherein, each of two sides of a rear end of the isolation insert plate 200 has a vertical engagement portion 230 to be engaged with the concave portion 140 of the two inner sides of the two lateral bodies 120. The first flexible cable 300 includes a first contact part 310 disposed on the upper surface 210 of the isolation insert plate 200. The second flexible cable 400 includes a second contact part 410 disposed on the lower surface 220 of the isolation insert plate 200. The upper insulating holding member 500 is disposed on an upper rear side of the engagement portion 230 and is located between the upper cover body 110 and the first flexible cable 300. As shown in the figures, the lower insulating holding member 600 is disposed on a lower rear side of the engagement portion 230, and each of two sides of the lower insulating holding member 600 has at least one buckle protruding portion 610 respectively and correspondingly buckled into the at least one buckle hole 130. The connector assembly further includes the flat spring 700 disposed in a flat spring engaging slot 150 on an outside of the upper cover body 110.

As shown in the figures, in the second embodiment of the present disclosure, the upper insulating holding member 500 and the isolation insert plate 200 are integrally formed. As shown in the figures, in the second embodiment of the present disclosure, a front end of the isolation insert plate 200 further includes an insert-plate tongue portion 240. As shown in the figures, the insert-plate tongue portion 240 has a trapezoidal shape of cross-section. When the connector assembly is connected to a corresponding connector interface, the trapezoidal shape facilitates the isolation insert plate 200 to easily accomplish the connection. A maximum height of the insert-plate tongue portion 240 is 1.8 mm. The isolation insert plate 200 further includes a jagged edge 250 disposed on the upper surface 210, and the jagged edge 250 is formed at a junction of the insert-plate tongue portion 240 and the upper surface 210. The isolation insert plate 200 further includes another jagged edge 250 disposed on the lower surface 220, and the another jagged edge 250 is formed at a junction of the insert-plate tongue portion 240 and the lower surface 220.

As shown in the figures, the first contact part 310 of the first flexible cable 300 and the second contact part 410 of the second flexible cable 400 also include jagged-edge arrayed front ends that correspond to the jagged edges 250, thereby being beneficial to improve assembling yields. When assembling the connector assembly, first, the first contact part 310 is disposed on the upper surface 210 of the isolation insert plate 200 and fixed, and then the second contact part 410 is disposed on the lower surface 220 of the isolation insert plate 200 and fixed. The first contact part 310 and the second contact part 410 can be connected and fixed on the upper surface 210 and the lower surface 220 by adhesives or other methods. Rear sections of the first flexible cable 300 and the second flexible cable 400 having an insulating layer can also be fixed by the adhesives or can only be aligned and abutted by cable ties or other means for facilitating subsequent use or line arrangement.

In addition, in the second embodiment of the present disclosure, when the at least one buckle protruding portion 610 of the lower insulating holding member 600 is buckled into the at least one buckle hole 130 of the two lateral bodies 120 of the inverted U-shaped case body 100, and the assemblement of the connector assembly is about to be accomplished, the upper insulating holding member 500, which is integrally formed with the isolation insert plate 200, and the lower insulating holding member 600 can hold the first flexible cable 300 and the second flexible cable 400 inbetween from up and down. The second contact part 410 of the second flexible cable 400 is also fixed into a gap 630 formed between a hold-up wall 620 of the lower insulating holding member 600 and the isolation insert plate 200 as shown in FIG. 13, thereby accomplishing the assemblement of the connector assembly. In the second embodiment of the present disclosure, the first flexible cable 300 and the second flexible cable 400 are flexible flat cables or flexible printed circuit cables. Furthermore, as shown in the figures, the at least one buckle hole 130 of the two lateral bodies 120 of the inverted U-shaped case body 100 is not a blind hole but a through hole.

Compared to existing connector assemblies, the connector assembly in the present disclosure does not use a multi-layered circuit board as a connector tongue, but uses the isolation insert plate as the connector tongue. Also, the isolation insert plate can optionally be integrally formed with the upper insulating holding member. Or, it can optionally be integrally formed with the lower insulating holding member, while the upper insulating holding member is integrally formed with the inverted U-shaped case body. Therefore, the connector assembly in the present disclosure not only has an extremely simple and compact structure, but also has a simple manufacturing process and a high reliability. More importantly, it is unnecessary to weld the multi-layered circuit board with flexible cables as in the conventional technology, which causes high-frequency transmission of electronic signals to undergo multi-media transmission, thereby increasing signal loss and degradation and reducing reliabilities.

The present disclosure has been described with preferred embodiments thereof. The preferred embodiments are not intended to limit the present disclosure, and it is understood that many changes and modifications to the described embodiments can be carried out without departing from the scope and the spirit of the disclosure that is intended to be limited only by the appended claims.

What is claimed is:

1. A connector assembly, comprising:
an inverted U-shaped case body comprising an upper cover body and two lateral bodies, wherein each of the two lateral bodies has at least one buckle hole, and two inner sides of the two lateral bodies respectively have a vertical concave portion;
an isolation insert plate comprising upper and lower surfaces, wherein each of two sides of a rear end of the isolation insert plate has a vertical engagement portion to be engaged with the concave portion;
a first flexible cable comprising a first contact part disposed on the upper surface of the isolation insert plate;
a second flexible cable comprising a second contact part disposed on the lower surface of the isolation insert plate;
an upper insulating holding member disposed on an upper rear side of the engagement portion and located between the upper cover body and the first flexible cable; and
a lower insulating holding member disposed on a lower rear side of the engagement portion, wherein each of two sides of the lower insulating holding member has at least one buckle protruding portion respectively and correspondingly buckled into the at least one buckle hole.

2. The connector assembly according to claim 1, wherein the upper insulating holding member and the isolation insert plate are integrally formed.

3. The connector assembly according to claim 1, wherein the lower insulating holding member and the isolation insert plate are integrally formed.

4. The connector assembly according to claim 3, wherein the upper insulating holding member and the inverted U-shaped case body are integrally formed.

5. The connector assembly according to claim 1, further comprising a flat spring disposed in a flat spring engaging slot on an outside of the upper cover body.

6. The connector assembly according to claim 1, wherein a front end of the isolation insert plate comprises an insert-plate tongue portion.

7. The connector assembly according to claim 6, wherein a maximum height of the insert-plate tongue portion is 1.8 mm.

8. The connector assembly according to claim 6, wherein the isolation insert plate further comprises a jagged edge disposed on the upper surface, and the jagged edge is formed at a junction of the insert-plate tongue portion and the upper surface.

9. The connector assembly according to claim 8, wherein the first contact part comprises a jagged-edge arrayed front end corresponding to the jagged edge.

10. The connector assembly according to claim 6, wherein the isolation insert plate further comprises a jagged edge disposed on the lower surface, and the jagged edge is formed at a junction of the insert-plate tongue portion and the lower surface.

11. The connector assembly according to claim 10, wherein the second contact part comprises a jagged-edge arrayed front end corresponding to the jagged edge.

12. The connector assembly according to claim 1, wherein the first flexible cable and the second flexible cable are flexible flat cables.

13. The connector assembly according to claim 1, wherein the first flexible cable and the second flexible cable are flexible printed circuit cables.
